(19) United States
(12) Patent Application Publication
(10) Pub. No.: US 2005/0126556 A1
(43) Pub. Date: Jun. 16, 2005

(54) Convertible outdoor appliance

(75) Inventor: Martin C. Bossler, Clemmons, NC (US)

Correspondence Address: GREER, BURNS & CRAIN, 300 S WACKER DR, 25TH FLOOR, CHICAGO, IL, 60606, US

(73) Assignee: CPD Associates, Inc.

(21) Appl. No.: 10/732,593

(22) Filed: Dec. 10, 2003

(51) Int. Cl. F24B 3/00; F24B 1/181; A47J 37/00

(52) U.S. Cl. 126/25 R; 126/519; 126/304 A

(57) ABSTRACT

A convertible outdoor appliance features a bowl that is configured to burn solid fuel and is mounted to at least one leg or pedestal. One or more screen sidewalls are removably supported by the bowl. The height of the bowl is adjustable between a barbecue grill position and a fireplace position. A lid is configured to fit atop the bowl and the sidewalls, whereby a barbecue grill is formed when the pedestal is in the barbecue grill position, said sidewalls are removed and said lid removably covers said bowl; and an outdoor fireplace is formed when the pedestal is in the fireplace position, and the sidewalls are releasably supported by the bowl.

### BACKGROUND OF THE INVENTION

This invention relates to a convertible apparatus for outdoor use. More specifically, it relates to a barbecue grill that is reversibly convertible to an outdoor fireplace.

Use of backyards for family activities is a popular pastime. Barbecue grills are available in a variety of shapes and sizes. Small grills are supported upon a tabletop, or other substrate, while larger units generally have an integrated cart, stand, legs or support assembly supporting them at a height convenient for cooking food. Many designs are known to support square, rectangular and round grills. Recently, oval-shaped grills have come on the market. Stands have been provided with three or four legs, or with carts of various styles.

Portable outdoor fireplaces have recently entered the marketplace and have been well regarded. The relatively small size of these portable fireplaces permits them to be easily moved from one location to another. Although they may be enjoyed in a backyard, portable fireplaces of this type can also be used in remote locations, such as when camping, picnicking or doing other similar outdoor activities. Sitting around a fire in the evening is relaxing, especially when the temperature drops after the sun goes down.

Although both of these types of outdoor appliances are immensely popular, many consumers presently prefer to own one or the other but not both. For some, limited storage is an issue. For others, it is the cost. Still others have small backyards and do not wish all of the green space taken up by these devices. People who enjoy camping may consider taking either a fireplace or a cooking appliance with them, but are not likely to have space to take both. Whatever the reason, sometimes it is detrimental to have separate products for outdoor grilling and fires.

One could buy either a barbecue grill or an outdoor fireplace and use it for both purposes, however, doing so is very inconvenient. Full size barbecue grills are relatively tall and have a bowl deep enough to maintain a distance between the charcoal and the food so that the food doesn't burn easily. When a traditional grill is used for a fire, those sitting around the fire are not able to watch it very well because it sits deep in the bowl. Using a barbecue grill for an outdoor fireplace requires that the lid be removed if the participants are to view any of the fire. Thus, heat is lost which could otherwise have been directed to the users.

Attempting to use an outdoor fireplace as a barbecue grill has similar problems. The outdoor fireplace generally has screened sidewalls to contain ash and sparks from the fire. In many cases, it is inconvenient to reach over the sidewalls or use the doors to put food on, turn it or remove it from the heat source. With the screened sidewalls, airflow control is difficult and raises issues of flare-ups and uneven cooking. Even where the sidewalls are removable, an outdoor fireplace is not an ideal cooking appliance. Since an outdoor fireplace typically features a low fire bowl for easy viewing of the fire, it is not at a convenient height for cooking. Constant stooping and bending over would be required to tend the food at such a low height. The shallower bowl of a fireplace would also require frequent turning of the food to prevent burning.

Another disadvantage of using a fireplace for cooking is the accumulation of ash in the bottom of the bowl. The shallow bowl of a fireplace makes it relatively easy to scoop ash to remove it from the bowl. Use of an ash-receiving can on a fireplace is inconvenient because the bowl is kept close to the ground.

U.S. Pat. No. 4,732,138 discloses a campfire cooking apparatus that includes a cooking grate that is suspended by a tripod over a fire bowl. The apparatus provides no walls to contain sparks or ash from the fire. When the cooking assembly is used, the cooking surface will be located close to the fire, which is just above ground level. A cook has to constantly bend over to care for food that is cooking. Although a lid is described for smothering the fire or acting as a rain shield, there no control of the fire during the cooking process.

An outdoor fireplace and fire screen assembly is described in U.S. Pat. No. 5,836,298. A traditional outdoor fireplace is fitted with a cooking grill that can be positioned at different locations. The fire screen assembly contains the fire, but it is inconvenient to work around the screen while cooking. Free flow of air through the screen allows the cooking fire to burn uncontrolled, while the low level of the bowl and cooking grate make is uncomfortable for the chef to tend the cooking food.

Removable fire screens are taught in U.S. Pat. No. 6,286,503 for the purpose of compact storage of an outdoor fireplace. Leg assemblies support the bowl close to the ground then extend upward through the lid to form handles. The removable fire screen assembly attaches to the leg extensions when in use. Disassembly of the leg assemblies is required to remove the lid and the fire screen assembly.

Thus, there is a need in the art for a combination barbecue grill and outdoor fireplace that is easy to use and comfortable for the user in either configuration.

### SUMMARY OF THE INVENTION

These and other advantages are met or exceeded by the improved convertible outdoor appliance of the present invention that is specifically designed to be used as either a barbecue grill or an outdoor fireplace. Adjustability of the bowl height provides convenience and comfort for the user when the appliance is in either the fireplace or the grill configuration.

More specifically, an improved convertible outdoor appliance of the present invention features a bowl that is configured to burn solid fuel mounted to at least one leg or pedestal. At least one screen sidewall is removably supported by the bowl. The appliance includes a means for adjusting the height of the bowl between a barbecue grill position and a fireplace position. A lid is configured to fit atop either the bowl or the sidewall. A barbecue grill configuration is formed when the pedestal is in the barbecue position, the sidewall is removed and the lid removably covers the bowl. An outdoor fireplace configuration is formed when the pedestal is in the fireplace position, the sidewall is releasably supported by the bowl and the lid is positioned atop the sidewall.

In a preferred embodiment, the one or more legs form a telescopic pedestal. By lengthening or shortening the pedestal using the telescopic action, the pedestal is adjustable to at least a barbecue grill position and a fireplace position.

The apparatus of the present invention is particularly advantageous because a single outdoor appliance is reversibly convertible from a barbecue grill to an outdoor fireplace without the use of tools. For those with limited space, there is now a single apparatus that has the functionality of both the grill and the fireplace, but does not require space to store, transport or use two separate, complete items.

Further, this convertible appliance allows the user to adjust the height of the bowl to a level appropriate to each purpose for which it is used. One embodiment uses a telescoping pedestal that lengthens for use when cooking or shortens to view a fire. The backyard chef need not be hunched over a short firepit. The campfire is low enough to radiate warmth to those around it.

Because the unit is intended to be used as a fireplace, at least one screen sidewall is included to be able to burn wood safely. Large sparks or pieces of hot ash that may fly from a crackling fire are caught in the screen and fall back into the firebowl to be consumed in the fire. To minimize inconvenience to the cook, the sidewall is easily removable and need not be used when the appliance holds a charcoal fire. Removal of the sidewall also allows for more precise control of the cooking fire by restraining airflow through adjustable vents. By adjusting the vents, the rate of combustion, and thus the temperature, is managed by limiting the amount of available oxygen. Closing the vents essentially stops oxygen flow, allowing the charcoal to be extinguished before it is entirely consumed without drowning it in water. The use of removable sidewall permits control of the charcoal burn similar to that achieved in a conventional charcoal grill.

In a preferred embodiment, no disassembly of the one or more legs is required to remove the lid or the screen sidewall of the outdoor appliance. When in place, the fire screen rests inside the top of the bowl and the lid fits atop the screen. The lid fits directly on the top of the bowl when the fire screen has been removed in the barbecue grill configuration.

### DETAILED DESCRIPTION OF THE DRAWINGS

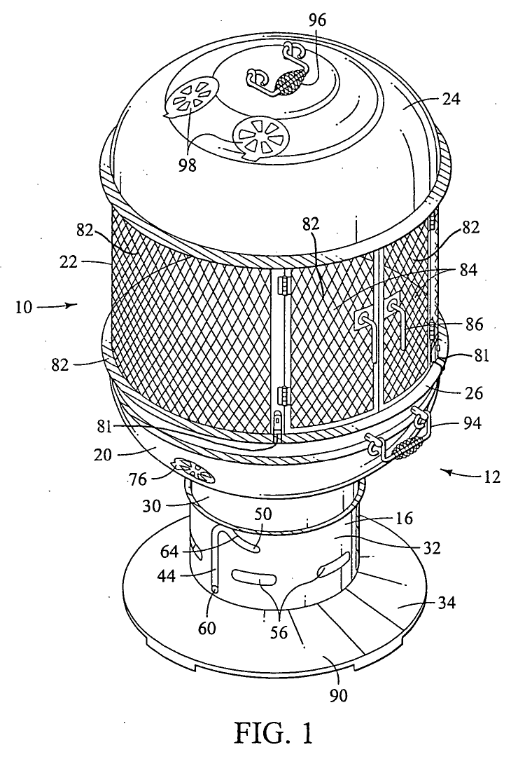

FIG. 1 is an elevated perspective view of an outdoor appliance of the present invention in the fireplace configuration;

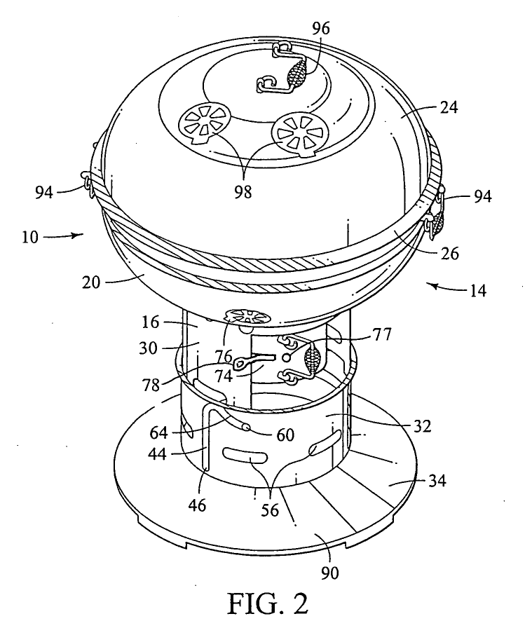

FIG. 2 is an elevated perspective view of the appliance of FIG. 1 in the barbecue grill configuration;

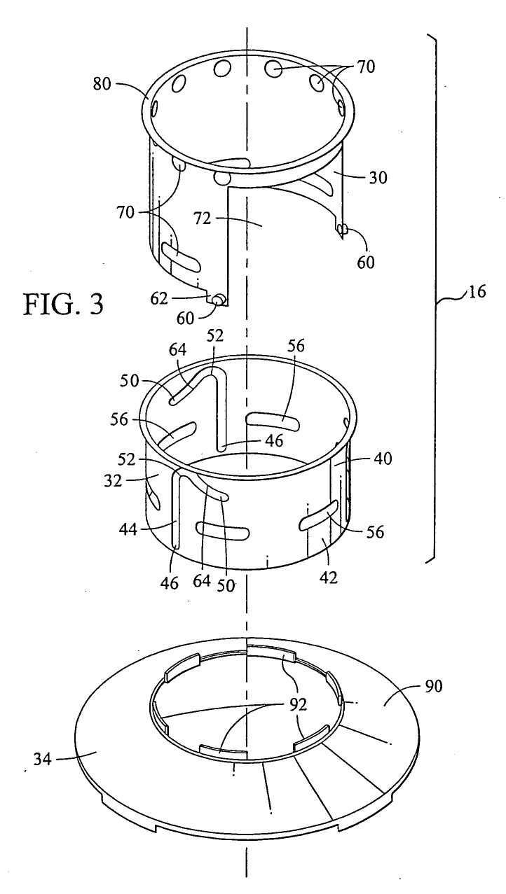

FIG. 3 is an exploded perspective view of the base and pedestal of the appliance of FIG. 1;

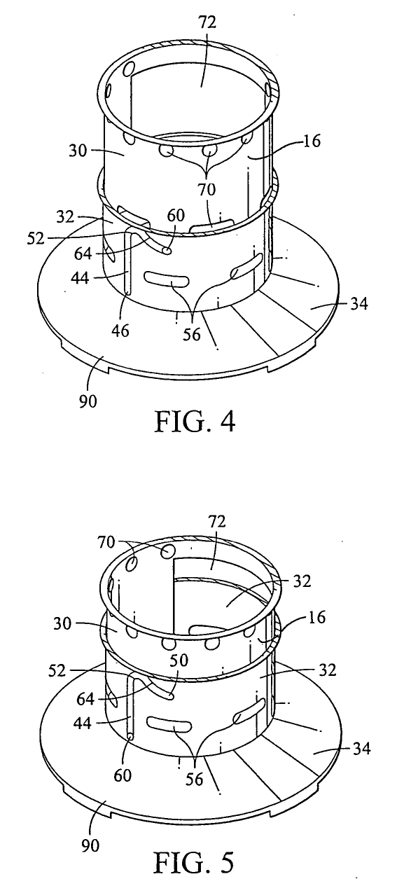

FIG. 4 is a perspective view of the base and pedestal of FIG. 2 in the first position; and

FIG. 5 is a perspective view of the base and pedestal of FIG. 1 in the second position.

### DETAILED DESCRIPTION OF THE INVENTION

Referring to FIGS. 1 and 2, an outdoor appliance apparatus, generally designated 10, is convertible between an outdoor fireplace configuration, generally designated 12, (FIG. 1) and a barbecue grill configuration, generally designed 14, shown in FIG. 2. The appliance 10 includes at least one pedestal or leg 16, a bowl 20 and at least one removable sidewall 22. In the preferred embodiment, multiple sidewalls 22 are provided. A lid 24 is configured to fit atop the sidewall 22 in the fireplace configuration 12 and on the bowl 20 in the barbecue configuration 14. In the discussion that follows, directional references are intended to refer to the appliance 10 when oriented as shown in FIGS. 1 and 2.

The one or more legs 16 hold the bowl 20 and the lid 24 off the ground or other substrate. The term pedestal 16 is intended to refer to a single leg used to support the bowl 20. Although use of a pedestal 16 is a preferred embodiment, other embodiments are contemplated that use a plurality of legs 16, such as three or four legs. The number of legs 16 is not important as long as the height of the bowl 20 is adjustable. Most commonly, the height of the bowl 20 will vary by changing the length of the legs 16 or by varying the position on the leg where the bowl is supported. Alternate methods are contemplated for varying the height of the bowl 20 regardless of the number of legs 16 involved.

Referring to FIGS. 1 and 2, the height of the bowl 20 preferably varies between at least the relatively taller barbecue grill position and the relatively shorter fireplace position. It is contemplated that some embodiments of the apparatus 10 are adjustable to more than two positions, with the additional positions being higher, lower or intermediate to the two positions discussed below. An intermediate position may be useful for cleaning the bowl, or a lower position to compact the apparatus 10 for storage or travel. The apparatus 10 is optionally adjustable to any number of positions in addition to the barbecue grill configuration 14 and the fireplace configuration 12.

In the barbecue grill configuration 14, the bowl 20 is held off the ground at a distance typically used for conventional barbecue grills and the lid 24 is positionable directly on a rim 26 of the bowl 20. With the lid 24 positioned directly on the bowl 20, the amount of combustion air is limited to control the cooking temperature. The height of the bowl 20 should be positioned to be comfortable for a cook to handle the food without having to stoop or bend. Preferably, at least one position of the bowl 20 corresponds to the height of a full size barbecue grill. In some embodiments, the rim 26 is greater than about 26 inches from the substrate in the barbecue grill configuration 14. Preferably, the rim 26 of the bowl 20 is between about 26 inches and about 32 inches from the substrate, and even more preferably between about 28 inches and about 31 inches.

The fireplace configuration 12 is designed to be conducive to sitting around a fire, watching the flames and being warmed by the radiant heat of the embers. In this configuration 12, the bowl 20 is closer to the substrate so that the fire is comfortably viewed from a sitting position. Preferably, at least one position of the bowl 20 corresponds to a height of a conventional outdoor fireplace, which is typically less than about 26 inches from the ground or other substrate. In this configuration 12, the rim 26 of the bowl 20 is preferably between about 21 inches and about 26 inches from the substrate, and even more preferably, between about 23 inches and about 25.5 inches. As is discussed in more detail below, in the fireplace configuration 12, the sidewall 22 is also present to contain the fire.

Although the present embodiments are discussed in terms of converting from a fireplace configuration 12 to a barbecue grill configuration 14, it is contemplated that an outdoor appliance 10 could be provided having a bowl 20 with an adjustable height for other purposes. For example, this height adjustment mechanism would be useful for use with a barbecue grill designed to provide a cooking surface at a comfortable height for cooks of varying heights. Still other embodiments are contemplated whereby a barbecue grill is adjustable for use by user from either a standing position or a sitting position, as might be useful by a wheelchair-bound cook. Thus, although height ranges are listed above to illustrate the best mode of the invention, the exact number of positions that are desirable or the exact rim heights that are utilized depend upon the specific uses for which the appliance 10 is designed.

Any method for adjusting the height of the bowl 20 is suitable for use with this apparatus and method. A preferred method of adjusting bowl 20 height is telescoping the pedestal 16 using a first cylinder 30 within a second cylinder 32. As shown, a base 34, discussed below, supports the second cylinder 32 and the first cylinder 30 attaches to the bowl 20. This is but one embodiment shown and it is contemplated that the pedestal 16 could be configured with the first cylinder 30 supported by the base and the second cylinder 32 attached to the bowl. It is further contemplated that the pedestal 16 need not be cylindrical. Telescoping parts are contemplated having a square, triangular or any cross sectional shape, as long as the parts are configured to slideably adjust the length of the pedestal 16.

Although telescoping of the pedestal or legs 16 is a preferred embodiment, any method of adjusting the bowl 20 height is suitable for use with this appliance 10. Other methods of adjusting the length of the leg 16 are also usable, including, instead of telescoping inside each other, two portions of a leg 16 being slidably attached beside each other. The bowl 20 height is also adjustable by changing the height of the bowl 20 on the one or more legs 16. For example, the legs 16 are protrudable through the bowl 20, attaching to the bowl at various heights. In another contemplated embodiment, the legs 16 are attachable to the bottom of the bowl 20 in the barbecue grill configuration 14, but the legs attach to the rim 26 of the bowl in the fireplace configuration 12, allowing the depth of the bowl to reside between the legs rather than atop them. The height of the bowl 20 is also contemplated as being adjustable by varying the angle of the legs 16 with respect to the substrate, mimicking the action of a pair of scissors. It is also contemplated that one or more adjustment methods be combined in a single embodiment.

Referring now to FIG. 3, the second cylinder 32 has an upper portion 40 and a lower portion 42. One or more cam tracks 44 has a second end 46 in the lower portion 42 of the second cylinder 32 to a first end 50 in the upper portion 40 to guide the first cylinder 30 as it telescopes to change the height of the pedestal 16. The preferred track 44 rises substantially vertically from the second end 46, curves around an arc 52 to one side and slopes slightly downward for a short distance to the first end 50, giving the track an overall shape similar to that of a shepherd's crook. In the preferred embodiment, a plurality of vents 56 are located around the side of the second cylinder 32 to admit fresh air for combustion.

At least one cam 60 for each cam track 44 is attached to the first cylinder 30 and positioned for interaction with the cam track. Preferably each cam 60 is located near a lower edge 62 of the first cylinder 30 to allow the first and second cylinders 30, 32 to nest compactly in the fireplace configuration 12. The cam 60 is optionally made of a separate piece that is attachable to the first cylinder 30, or it can be shaped as an integral part of the first cylinder during its manufacture, as by casting, molding, or any other means known in the art.

Interactions of the cam 60 with the cam track 44 and how these components relate to the pedestal 16 length are shown in FIGS. 4 and 5. If the first and second cylinders 30, 32 completely separate from each other, it could be inconvenient for the user to replace them, particularly if they fit snugly together. In a preferred embodiment, use of the cam 60 and the cam track 44 prevents separation of the first and second cylinders 30, 32 and guides the relative movement of the cylinders. When the cam 60 is at the second end 46 of the cam track 44, the first and second cylinders 30, 32 substantially nest within each other, providing a short pedestal 16 for use with the fireplace configuration. Movement of the first cylinder 30 upward or away from the base 34 lengthens the height of the pedestal 16. Rotation of the first cylinder 30 with respect to the base 34 allows the cam 60 to negotiate the arc 52. As shown, rotation is in the counter clockwise direction but is equally suitable in any direction. The first cylinder 30 is then lowered slightly to allow the cam 60 to settle at the first end 50 of the cam track 44 in the barbecue grill configuration 14 where the bowl 20 is held at a height greater than in the fireplace configuration 12. Downward slope of the cam track 44 near the first end 50 acts as a lock 64 that prevents the pedestal 16 from collapsing to the fireplace configuration 12 unexpectedly as might be possible if the first end 50 of the track 44 were merely a horizontal space. In the barbecue grill configuration 14, the bowl 20 is at a height comfortable for cooking. Many configurations are contemplated for the cam track 44. From the second end 46, the angular configuration of the track is variable. At the cam track 44 position closest to the upper portion 40 of the second cylinder 32, instead of an arc 52, a more angular shape is contemplated. The shape of the first end 50 is optionally substantially horizontal rather than sloping. The exact shape of the track 44 is unimportant as long as it guides the telescoping action of the pedestal 16 and holds the pedestal securely in a selected elevated position.

Referring now to FIGS. 2 and 3, the pedestal 16 optionally includes additional features such as multiple air vents 70 and an opening 72 for access to an ash receiver 74. Location of the air vents 70 varies with the design of the pedestal 16. Numerous air vents 70 provide generous airflow through the pedestal 16 to the bowl 20 regardless of the position of the pedestal 16. As is known in the art, the ash receiver 74 is removably attachable to the bowl 20, and collects the ash for easy disposal. Preferably, the ash receiver 74 is held within the pedestal 16 in the attached position (FIG. 2). If other leg configurations are used, the ash receiver 74 is optionally placed adjacent or between one or more legs 16. When the ash receiver 74 needs to be emptied, it is detached from the bowl 20 and removed through the opening 72 in the first cylinder 30. As shown, the ash receiver 74 is most easily emptied when the pedestal 16 is in the barbecue grill position. The appliance 10 is optionally designed to utilize the ash receiver 74 in both the barbecue grill configuration 14 and the fireplace configuration 12.

As shown in FIG. 2, control of the flow of combustion air from the pedestal 16 into the inside of the bowl 20 in the barbecue grill configuration 14 is controllable by use of adjustable vents 76 located on the bowl and/or the ash receiver, as is well known in the art. Any type of vent that controls the inflow of air from outside the bowl is suitable. An alternative vent 77 that is particularly useful on the ash receiver 74 includes an aperatured ring (not shown) that rotates via movement of a handle 78 to align the ring apertures with the vent. Adjustment of the vents 76, 77 controls air flow to produce the desired cooking temperature. If it is desired to extinguish combustion in the charcoal briquettes, the vents 76, 77 are closed to effectively stop flow of oxygen to the charcoal and smother the fire.

Around the top of the pedestal 16 is a flange 80 with which to attach it to the bowl 20. In the embodiment shown, the flange 80 is positioned on the first cylinder 30, placing the bowl 20 at the end of the pedestal 16 opposing the base 34. It is also contemplated that the flange 80 be positioned on the second cylinder 32.

The bowl 20 is configured to accommodate a wood in the form of logs or lumber for burning or charcoal for use in cooking. The rim 26 around the top edge of the bowl 20 engages and receives the lid 24. The rim 26 also engages, provides a base for, or surrounds the one or more sidewalls 22 in the fireplace configuration 12. Although the container which holds the fire is referred to as the bowl 20, it need not be strictly bowl-shaped. The shape of the bowl 20 is concave, such as ovoid, box-shaped or frustoconical, or any other shape having a depth that urges the fuel to remain contained within the rim 26 even when the fuel shifts position, as during burning.

Referring back to FIG. 1, when it is desirable to use the appliance 10 as an outdoor fireplace 12, the pedestal 16 is placed in the fireplace position and the sidewall 22 is supported by the bowl 20, using either direct support or indirect support. Direct support includes resting of the sidewall 22 on or attaching of the sidewall to either the bowl 20 or its rim 26. It is also contemplated that an intermediate support, such as a pole or flange (not shown), is supported by or attached to either the bowl 20 or its rim 26. One method of attaching the sidewall 22 or panels 82 to a support pole utilizes a connector (not shown) on the panel to engage a slot on the pole as taught in U.S. Patent Publication No. 2002/0185122-A1, herein incorporated by reference in its entirety. The sidewall 22 that is held by or attached to the intermediate support may be then indirectly supported by the bowl 20. Other attachment systems for the sidewalls 22 are contemplated.

The sidewall 22 optionally includes a fastening mechanism 81, such as a latch, to releasably attach the sidewall 22 to the bowl 20 to lock it in place while the fireplace 12 is in use. The preferred latch 81 is similar to that used on a suitcase, and is well known. Many types of fastening mechanisms 81 are suitable to releasably attach the sidewall 22 to the bowl 20, including friction fitting of the sidewall into a spring clip, opposing mounting brackets connected by a fastener or use of a pin that engages a lock or opening, similar to a deadbolt. A cam and a cam track, similar to those used on the pedestal 16, are also suitable as the locking mechanism 81. Use of the locking mechanism 81 prevents movement of the sidewall 22 in the unlikely event that a lateral or upward force is applied to it.

In this configuration, the screen sidewall 22 and the lid 24 contain sparks and ash that may fly from inside the fireplace while the fire is burning. The sidewall 22 is suitably any size mesh that is useful in the context of a fireplace screen. It is unimportant whether the sidewall 22 is constructed of a single screen or whether two or more of the panels 82 are joined together to form the sidewall. If a plurality of panels 82 are used, they are connectable by any means known in the art, including one or more tabs that engage an equal number of slots, hooks or teeth that interleave with the teeth of an adjacent panel (not shown). One or more of the panels 82 are preferably movable to form one or more doors 84 through which fuel is conveniently added to the fire. In a preferred embodiment, the sidewall 22 is of unitary construction and the doors 84 are hinged to the sidewall 22 and swing outwardly. A hook, latch or other locking mechanism 86 should be installed on one or more of the doors 84 or the sidewall 22 to hold the door closed when not in use.

Referring now to FIG. 3, where a single leg or pedestal 16 is used, the appliance 10 preferably rests on the base 34 including a rim 90 and one or more pedestal supports 92, and is configured to support the appliance 10 on a substrate. As the appliance 10 is intended for outdoor use, a wide ring or frustum is a preferable shape for the rim 90 for stability on uneven surfaces. The base 34 can be any shape, including, but not limited to, a ring, a frustum, a square, a rectangle, an “X” or a cross. In the embodiment shown, the base 34 is in the shape of a shallow frustum. At the outer edge of the frustum is the rim 90 which is finished to provide a safe, smooth surface.

Preferably, at the inside of the base 34 is at least one pedestal support 92 which holds the pedestal 16 in place and limits lateral movement of the pedestal on the base. The preferred pedestal supports 92 are tabs that are substantially vertical, oriented upwardly from the base 34. The pedestal 16 includes the lower portion 42 which rests on the base 34 with the tabs 92 inside it, preventing the pedestal 16 from moving from side to side. Another embodiment includes a recessed surface (not shown) upon which the lower portion 42 of the pedestal rests.

Optionally, the lower portion 42 of the pedestal 16 is configurable to be fixed to the base 34. In this case, any locking mechanism, including a fastener, is useful to hold the base 34 and the pedestal 16 together. The tabs 92 may be fixed with a hook portion that fits into a slot or anchor on the pedestal. In other embodiments, the base 34 is an integral portion of the pedestal 16, such as where the lower portion flares 42 outward to form a stable base. The number of parts used to form the base 34 and the pedestal 16 are unimportant as long as both functions are present.

All components of the appliance 10 are preferably made of materials that are suitable for use with fire and in the out-of-doors. Metals are most suitable, including iron, steel, aluminum and stainless steel. Any or all of the parts are optionally treated with one or more materials to reduce rust or otherwise improve the product performance. Examples include suitable coatings, such as powdered coatings, porcelain or high temperature paints.

Additional features are optionally included on the appliance 10 to make it more convenient or useful to the user. Racks or grates (not shown) are usually used to support the food or charcoal at appropriate distances from each other. One or more handles 94 are useful on the bowl 20 to assist in converting between the two configurations 12, 14 and to assist when moving the apparatus 10 from one location to another. Preferably, a pair of handles 94 is mounted at diametrically opposing sides of the bowl 20. Another handle 96 is preferably attached to the lid 24 to assist its removal, particularly when it is hot. One or more exhaust vents 98 are optionally positioned on the lid 24 to promote airflow through the appliance 10. Warm air rises and collects under the lid 24. Opening of the exhaust vents 98 allows the warm air to escape, drawing fresh air and oxygen in through the vents 76 on the bowl or the ash receiver 77. As the air flows though the pedestal 16 and the bowl 20, it is heated by combustion, wherein it rises to the lid 24 and exits through the exhaust vents 98.

In operation, a preferred embodiment of the outdoor appliance 10 in the barbecue grill configuration 14 has the pedestal 16 in the barbecue grill position and the lid 24 resting directly on the rim 26 of the bowl 20. To convert the barbecue configuration 14 to the fireplace configuration 12, the lid 24, if present, and the food rack is removed. The ash receiver 74 may be removed, if necessary or desired, before the pedestal 16 is shortened. With the base 34 remaining in position, the bowl 20 is raised. During the upward movement of the bowl 20, the first cylinder 32 slides within the second cylinder 30 to shorten the pedestal 16. As the cam 60 reaches the arc 52 of the cam track 44, the bowl is rotated slightly to allow the cam to follow the shape of the cam track. After the cam 60 rounds the arc 52 of the track 44, the bowl 20 is lowered to the fireplace configuration 12 where the cam comes to rest at the first end 50 of the cam track 44. The screen sidewall 22 is placed in position on or within the rim 26 of the bowl 20 and the lid 24 is positioned atop the sidewall. The appliance 10 is then ready to accept wood or other combustible materials for a fire.

When it is desirable to return the appliance 10 to the barbecue grill configuration 14 from the fireplace configuration 12, the lid 24 is removed, if present. The sidewalls 22 are removed from the rim 26 of the bowl 20 and stored in preparation for subsequent use. Movement of the pedestal 16 from the fireplace position to the barbecue grill position allows the cam 60 to follow the cam track 44. In the embodiment shown, the bowl 20 is raised upwards until the cam 60 reaches the arc 52 of the track 44, then rotated and slightly lowered until the cam 60 rests at the first end 46 of the cam track. If the ash receiver 74 was removed in the fireplace configuration 12, it is preferably replaced for use in the barbecue grill configuration 14. The outdoor appliance 10 is then ready to accept solid fuel for cooking use.

While a particular embodiment of the improved convertible outdoor appliance has been shown and described, it will be appreciated by those skilled in the art that other configurations are possible in addition to those discussed above. Embodiments are contemplated whereby the ash receiver depends from the bowl, which is supported by three or four adjustable legs. Although the embodiments were discussed in terms of a charcoal grill, the apparatus and method of this invention are adaptable to be used with gas or combination gas/charcoal grills. These and other changes and modifications may be made thereto without departing from the invention in its broader aspects and as set forth in the following claims.

1. An apparatus convertible between a barbecue grill configuration and a fireplace configuration, comprising:
at least one leg;
a bowl configured to burn solid fuel mounted to said at least one leg;
a sidewall supported by said bowl in said fireplace configuration and removable from said bowl in said barbecue grill configuration; and
means for adjusting the height of the bowl between at least a barbecue grill position and a fireplace position.

2. The apparatus of claim 1 further comprising a lid that fits atop said bowl in said barbecue grill configuration and fits atop said sidewall in said fireplace configuration.

3. The apparatus of claim 1 further comprising an ash receiver removably depending from said bowl.

4. The apparatus of claim 3 wherein said ash receiver further comprises one or more adjustable vents.

5. The apparatus of claim 1 wherein said at least one leg comprises a pedestal.

6. The apparatus of claim 5 further comprising an ash receiver depending from said bowl and positioned within said pedestal.

7. The apparatus of claim 5 wherein said means for adjusting the height of said bowl comprises said pedestal being configured for telescoping between said grill position and said fireplace position.

8. The apparatus of claim 5 wherein said pedestal further comprises a first cylinder that telescopes relative to a second cylinder.

9. The apparatus of claim 8 wherein said first cylinder comprises at least one of a cam and a cam track and said second cylinder comprises at least the other of said cam and said cam track.

10. The apparatus of claim 6 wherein said pedestal further comprises an opening configured to receive said ash receiver.

11. An apparatus convertible between a barbecue grill configuration and a fireplace configuration, comprising:
one or more telescoping legs;
a bowl configured to burn solid fuel mounted to said legs; and
a screen sidewall supported by said bowl in said fireplace configuration and removable from said bowl in said barbecue grill configuration.

12. The apparatus of claim 11 wherein said one or more legs comprise a pedestal.

13. The apparatus of claim 11 wherein said telescoping pedestal is configured to adapt between a barbecue grill position in said barbecue grill configuration and a fireplace position in said fireplace configuration.

14. The apparatus of claim 12 wherein said bowl further comprises an ash receiver depending from said bowl inside said pedestal, and said pedestal further comprises an opening configured for accessing said ash receiver.

15. The apparatus of claim 13 wherein said pedestal further comprises a cam and a cam track.

16. The apparatus of claim 15 wherein said cam track is generally crook-shaped.

17. The apparatus of claim 11 wherein said pedestal further comprises an inner cylinder and an outer cylinder slidably connected by said cam and said cam track.

18. A process for reversibly adapting a convertible outdoor appliance from barbecue grill configuration to a fireplace configuration comprising:
reversibly adjusting the height of a bowl configured to burn a solid fuel from a barbecue grill position to a fireplace position; and
installing at least one removable screen sidewall onto the bowl.

19. The process of claim 18 wherein said adjusting step comprises telescoping one or more legs that support the bowl.

20. The process of claim 18 further comprising locking said bowl in the barbecue grill position.

21. The process of claim 20 wherein said locking step comprises rotating the bowl with respect to a base.

22. The process of claim 18 further comprising removing a lid prior to the adjusting step.

23. The process of claim 22 further comprising replacing the lid subsequent to said installing step.

24. The process of claim 18 further comprising latching the sidewall to the bowl following said installing step.
